(19) United States
(12) Patent Application Publication
(10) Pub. No.: US 2007/0262906 A1
(43) Pub. Date: Nov. 15, 2007

(54) Capacitive ground antenna

(76) Inventors: Yona Haim, Tiberias (IL); Snir Azulay, Tiberias (IL)

Correspondence Address: ABELMAN, FRAYNE & SCHWAB, 666 THIRD AVENUE, 10TH FLOOR, NEW YORK, NY, 10017, US

(21) Appl. No.: 11/803,184

(22) Filed: May 10, 2007

Related U.S. Application Data
(60) Provisional application No. 60/799,956, filed on May 11, 2006.

(51) Int. Cl. H01Q 1/38

(52) U.S. Cl. 343/700 MS; 343/702

(57) ABSTRACT

An antenna, including a ground plane and a conductor having a feed post configured to galvanically connect to circuitry operative in a band of frequencies. The antenna further includes a conductive plate galvanically connected to the ground plane and capacitively coupled to a region of the conductor so as to cause the conductor to resonate in the band of frequencies.

### CROSS-REFERENCE TO RELATED APPLICATION

This application claims the benefit of U.S. Provisional Patent Application 60/799,956, filed 11 May, 2006, which is incorporated herein by reference.

### FIELD OF THE INVENTION

The present invention relates generally to antennas, and specifically to grounding of antennas that may be used in multiple bands.

### BACKGROUND OF THE INVENTION

Electronic devices which receive and transmit electromagnetic radiation, such as laptop computers, are continually reducing in size. The reduction in size typically constrains an antenna of the device, so that the performance of the antenna may be adversely affected.

There is thus a need for an improved antenna.

### SUMMARY OF THE INVENTION

In embodiments of the present invention, an antenna is formed by coupling a conductor capacitively to a conductive plate. The conductive plate is galvanically connected to a ground plane and acts as a gamma match for the antenna. The conductor is configured to galvanically connect to circuitry that operates in one or more bands of frequencies, and the capacitive coupling between the conductive plate and the conductor may be varied so as to cause the conductor to resonate in the one or more frequency bands. Using capacitive coupling enables the bandwidth of the antenna to be increased, and a physical size of the antenna to be decreased. In addition, the capacitive coupling may be varied to match the impedance of the antenna to the impedance of circuitry coupled to the antenna.

In some embodiments the conductor is in the form of resonating multipole sections. For example, the conductor may comprise two sections, one resonating in a relatively high band of frequencies, the other resonating in a relatively low band of frequencies. The two sections may be configured to be generally similar to those of an inverted “F” antenna. In another embodiment, the conductor is in the form of a folded monopole.

In a disclosed embodiment the conductor is completely formed from a planar conducting sheet. Alternatively, the conductor may be formed from a planar conducting sheet connected galvanically to a conducting rod.

In one embodiment the conductor comprises a feed post which is galvanically coupled to the circuitry, and a reactive matching circuit is coupled between the feed post and the conductive plate. Varying the reactance of the matching circuit, together with varying the capacitive coupling, gives increased flexibility in tuning the antenna.

In an alternative embodiment, a dimension of the ground plane may be varied so that a resonant frequency of the conductor together with the ground plane is included in the one or more frequency bands. Typically the dimension is a length of the ground plane, and the resonant frequency is a lower frequency sub-band in the one or more bands of frequencies.

There is therefore provided, according to an embodiment of the present invention, an antenna, including:

a ground plane;

a conductor having a feed post configured to galvanically connect to circuitry operative in a band of frequencies; and

a conductive plate galvanically connected to the ground plane and capacitively coupled to a region of the conductor so as to cause the conductor to resonate in the band of frequencies.

Typically, the conductor includes a planar sheet, and the planar sheet and the conductive plate may be in a common plane. The conductive plate is capacitively coupled to the region of the conductor according to a capacitance, and the conductive plate and the planar sheet may be separated by one or more insulating spaces configured to form the capacitance. In some embodiments a dielectric may be inserted in the one or more insulating spaces to form the capacitance.

Alternatively, the planar sheet and the conductive plate may be in different planes. The conductive plate may be capacitively coupled to the region of the conductor according to a capacitance, and the conductive plate and the planar sheet are typically separated by one or more insulating spaces configured to form the capacitance. In an embodiment a dielectric may be inserted in the one or more insulating spaces to form the capacitance. Alternatively or additionally, the conductive plate and the planar sheet overlap to form an insulating space therebetween so as to generate the capacitance.

In a disclosed embodiment the antenna includes a conductive rod which is galvanically connected to a portion of the planar sheet.

Typically the band of frequencies includes two or more sub-bands of frequencies, and the conductor includes respective sections, each of the respective sections resonating in one of the two or more sub-bands of frequencies.

In one embodiment the ground plane includes a dimension which is configured so as so as to cause the conductor and the ground plane to resonate in the band of frequencies.

Typically, the conductive plate is capacitively coupled to the region of the conductor according to a capacitance, and the capacitance is arranged to match impedances of the circuitry and the conductor.

The region may be selected according to a bandwidth of the band of frequencies.

The ground plane, the conductor, and the conductive plate may be configured as an inverted F antenna or as a folded monopole antenna.

There is further provided, according to an embodiment of the present invention, a method for forming an antenna, including:

providing a ground plane;

galvanically connecting a feed post of a conductor to circuitry operative in a band of frequencies;

galvanically connecting a conductive plate to the ground plane; and

capacitively coupling the conductive plate to a region of the conductor so as to cause the conductor to resonate in the band of frequencies.

The present invention will be more fully understood from the following detailed description of the embodiments thereof, taken together with the drawings in which:

### BRIEF DESCRIPTION OF THE DRAWINGS

FIGS. 1A and 1B are schematic diagrams of a multiband antenna, according to an embodiment of the present invention;

FIGS. 2A and 2B are schematic diagrams of a multiband antenna, according to an alternative embodiment of the present invention;

FIGS. 3A and 3B are schematic diagrams of a multiband antenna, according to a further alternative embodiment of the present invention;

FIGS. 4A, 4B, 4C and 4D are schematic equivalent circuits of antennas, according to an embodiment of the present invention; and

FIG. 5 is a schematic diagram of a folded monopole antenna, according to an alternative embodiment of the present invention.

### DETAILED DESCRIPTION OF EMBODIMENTS

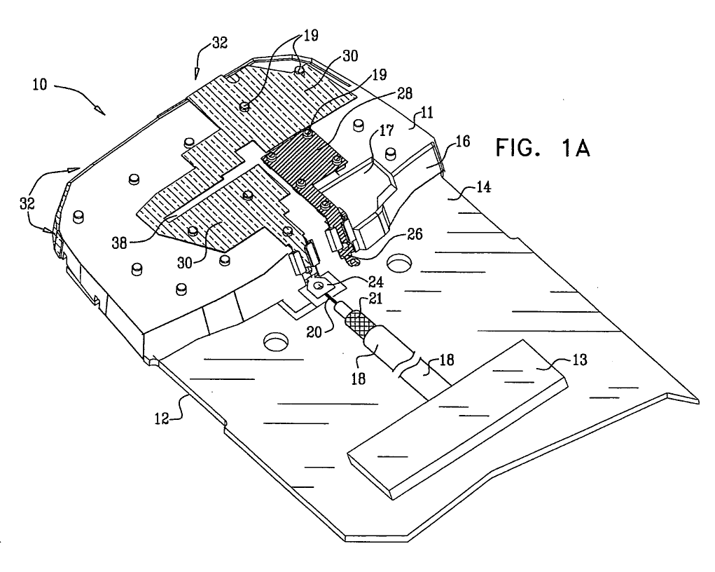

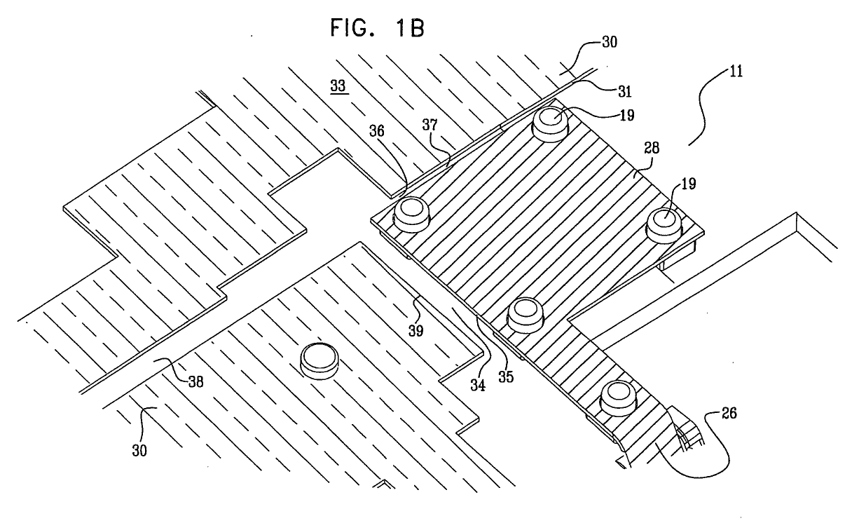

Reference is now made to FIGS. 1A and 1B, which are schematic diagrams of a multiband antenna 10, according to an embodiment of the present invention. FIG. 1A is a perspective view of antenna 10, and FIG. 1B is a perspective view of a detail of the antenna. Antenna 10 may be generally classified as an inverted “F” antenna, and may be constructed on any insulating material. Typically, as is assumed herein by way of example, antenna 10 is constructed on an insulating support 16 which is mounted on a printed circuit board (PCB) 12. Antenna 10 is formed on an antenna supporting surface 11 of support 16, the surface being of the order of 5 mm above PCB 12. A section 14 of the PCB is a conductive ground plane. Typically, as illustrated in FIG. 1A, in a region 17 of the PCB beneath support 16, there is no conductive ground plane. In an alternative embodiment of the present invention, section 14 extends at least partly into region 17. Elements of antenna 10, described in more detail below, may be mechanically connected to support 16 by any convenient means. Hereinbelow, by way of example, insulating posts 19 are assumed to hold the elements to the support, the elements having holes corresponding to the positions of posts 19.

Antenna 10 comprises a feed post 24, a section 30, and a section 32, all of which are advantageously formed from one planar conductive sheet which is cut and bent to shape, and which is attached to support 16 as described above. Section 30 comprises the section of the sheet on support 16 and acts as a short arm resonating element of the antenna. Section 32 comprises the section of the sheet attached to the side of support 16, and acts as a long arm resonating element of the antenna. Thus section 30 acts as a conductor which resonates in a relatively high frequency band, and section 32 acts as a conductor which resonates in a relatively low frequency band. Dimensions of the sections may be varied, for example by incorporating tuning and/or radiating slots in the sections, to alter the tuning of the sections. Thus, dimensions of a slot 38 in section 30 may be altered to vary the tuning of the antenna in the relatively high band. In some embodiments, dimensions of ground plane section 14 may also be varied to alter the tuning of the antenna. Typically a length of section 14 is so varied, and the length is selected so that a resonant frequency of section 14 with section 30, or with section 32, is within a particular band of frequencies.

Antenna 10 is fed by a coaxial cable 18 having a central conductor 20 connected to feed post 24. A ground shield 21 of the coaxial cable is connected to ground plane 14. Other methods for feeding antenna 10 may be used, such as for example a microstrip, and will be familiar to those having ordinary skill in the art. The feed mechanism couples circuitry 13, typically mounted on PCB 12, with antenna 10. Circuitry 13 typically comprises a receiver and/or a transmitter.

Antenna 10 comprises a ground plate element 28. Ground plate element 28 is a conductive sheet that is attached to support 16, and the ground plate is galvanically connected by a tab 26 to ground plane 14. In contrast with a “standard” inverted F antenna which has a ground that is galvanically connected to its radiating elements, the ground plate element of embodiments of the present invention is not galvanically connected to either section 30 or section 32 of antenna 10. Instead of being galvanically connected to these sections, element 28 is capacitively coupled to section 30, so that element 28 acts as gamma match for antenna 10. Thus, there is an insulating space 34 between a first part of section 30 and ground plate element 28, and an insulating space 36 between a second part of section 30 and the ground plate element. Typically, the width of the insulating spaces is of the order of 0.5 mm or less.

In antenna 10 ground plane element 28 and section 30 may or may not be coplanar. By way of example, element 28 is assumed to be maintained by posts 19 substantially in a plane 33 comprising section 30. The capacitance between the section and the ground plane element, which forms the capacitive coupling, is generated substantially between an edge 31 of section 30 and an upper edge 37 of element 28, and between an edge 39 of section 30 and a side edge 35 of element 28. Edge 31 and 39 comprise a region of section 30 that capacitively couples to element 28.

Varying the capacitive coupling affects the bandwidth and/or resonant frequencies of resonant elements of the antenna 10. Typically, as the coupling increases, the bandwidth of each element increases, and overall dimensions of the antenna elements may be decreased without adversely affecting the antenna performance. In addition, varying the capacitive coupling enables the impedance of antenna 10 to be correctly matched to the desired impedance of cable 18.

Methods for adjusting the capacitive coupling include:
Changing the length and/or the width of space 36, and/or changing the length and/or the width of space 34, typically by adjusting dimensions of element 28.
Applying a dielectric within at least part of space 36 and/or 34, typically enabling element 28 to be reduced in size compared to systems which do not use a dielectric.
Altering the position of ground plate element 28 with respect to section 30, typically by altering the dimensions of the section. Typically, the position of the ground plate element is adjusted so that it is relatively close to feed post 24. In this case the capacitive coupling of the ground plate element is substantially with an initial feed region, which includes edges 31 and 39, the high band section, i.e., section 30.
Changing the dimensions of ground plane 14 that extend into region 17.

In an alternative embodiment of antenna 10, ground plate element 28 is not co-planar with section 30, and the separation between the element and the section is sufficient to enable them to overlap. In the alternative embodiment, in addition to the methods given above for altering the capacitive coupling, the coupling may also be altered by adjusting the overlap between the section and the ground plate element, and/or adjusting a separation distance between the plane of the ground plate element and the plane of the section.

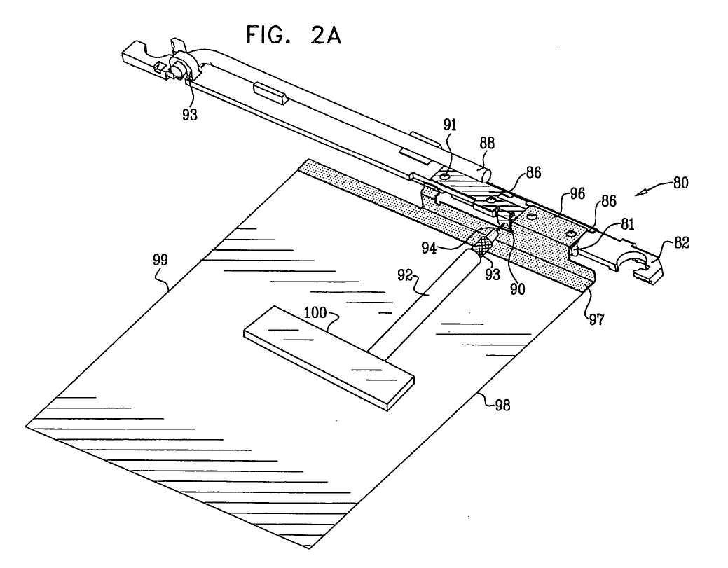

FIGS. 2A and 2B are schematic diagrams of a multiband antenna 80, according to an alternative embodiment of the present invention. FIG. 2A is a perspective view of antenna 80, and FIG. 2B is a perspective view of a detail of the antenna. Antenna 80 may be classified as an inverted F antenna, and by way of example is constructed on an insulating carrier 82. A conductive ground plate element 96, performing generally the same function as element 28 (FIGS. 1A, 1B), is mechanically fixed to carrier 82. Herein the mechanical connection is assumed to be implemented by posts 91 of the carrier mating with corresponding holes in element 96. Also, element 96 is supported by an insulating support 81 which protrudes from carrier 82, and which positions a plane 83 of element 96 above a plane 85 of the surface of carrier 82.

Ground plate element 96 may advantageously be formed as part of a bracket 97. Element 96 is galvanically connected, typically via bracket 97, to a conducting ground plane 98. Ground plane 98 is assumed, by way of example, to be formed on a PCB 99.

Antenna 80 also comprises a conductive section 86 having a feed post 90. The section and feed post are advantageously formed from one planar conductive sheet which is cut and bent to shape, and which is attached to carrier 82 by posts 91 mating with corresponding holes in section 86. Section 86 is attached to carrier 82 so that the section is beneath plane 83 of ground plate element 96. However, although the section and ground plate element 96 do not galvanically touch, there is no requirement that element 96 and the section are in different planes. By way of example, a portion 87 of section 86 is assumed to be overlapped by, but not to galvanically contact, ground plate element 96. Section 86 acts as short arm of antenna 80, and dimensions of the short arm may be varied so that the section resonates in a relatively high frequency band. Dimensions of the section may be varied by incorporating tuning and/or radiating slots in the section, such as a slot 84, to alter the tuning of the section, generally as described above for antenna 10.

A rod 88, typically a cylindrical conducting wire or a planar section, is galvanically connected to section 86, and is fixedly connected to carrier 82 by a retaining clip 93. A length of rod 88 may be selected, and dimensions of the part of section 86 connected to the rod may be varied, so that the rod together with the connected part form a long arm of antenna 80 that resonates in a relatively low frequency band. Typically, using rod 88 as a cylindrical element connected to planar section 86 improves the operation performance of the long arm compared to using just planar sections.

Antenna 80 may be fed substantially as antenna 10. Herein, by way of example, antenna 80 is assumed to be fed by a coaxial cable 92 having a central conductor 94 connected to feed post 90. A ground shield 93 of the coaxial cable is connected to ground plane 98. The feed mechanism couples circuitry 100, typically mounted on PCB 99, with antenna 80. Circuitry 100 typically comprises a transmitter and/or a receiver.

As for antenna 10, in antenna 80 ground plate element 96 is not galvanically connected to section 86. Rather, as for antenna 10, element 96 is capacitively coupled to the section. There is an insulating space 102 between an edge 103 of section 86 and ground plate element 96, and an insulating space 100 between portion 87 and the ground plate element. A capacitance for space 102 is substantially dependent on a separation between an edge 101 of element 96 and edge 103 of section 84, and the common length of the edges. A capacitance for space 100 is substantially dependent on the separation between portion 87 and element 96, and the common area of overlap. Typically, the dimensions of the separations are similar to that of the insulating spaces in antenna 10.

The capacitive coupling of antenna 80 may be varied using generally the same methods as those for antenna 10, described above. Thus, capacitive coupling of antenna 80 may be varied by changing dimensions of spaces 100 and/or 102, changing dimensions and/or positions of elements defining the spaces, and/or positioning a dielectric at least partly in one or both of the spaces. Variation of the capacitive coupling produces generally similar results for both antennas. Thus, varying the capacitive coupling of antenna 80 may be used to correctly match the antenna to its feed, as well as to alter the bandwidth of section 86 and/or rod 88.

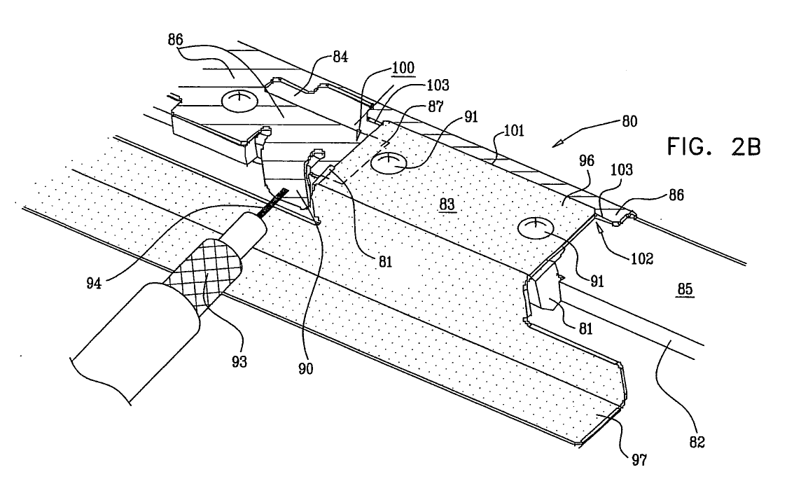

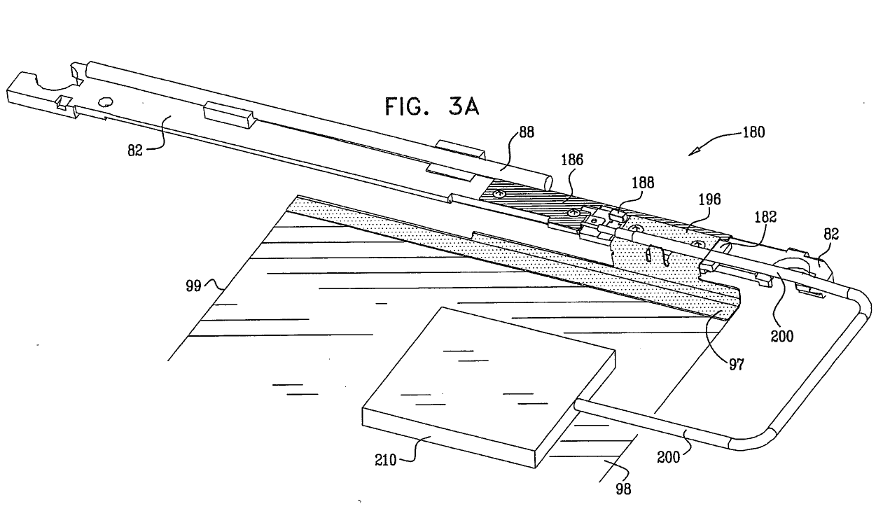

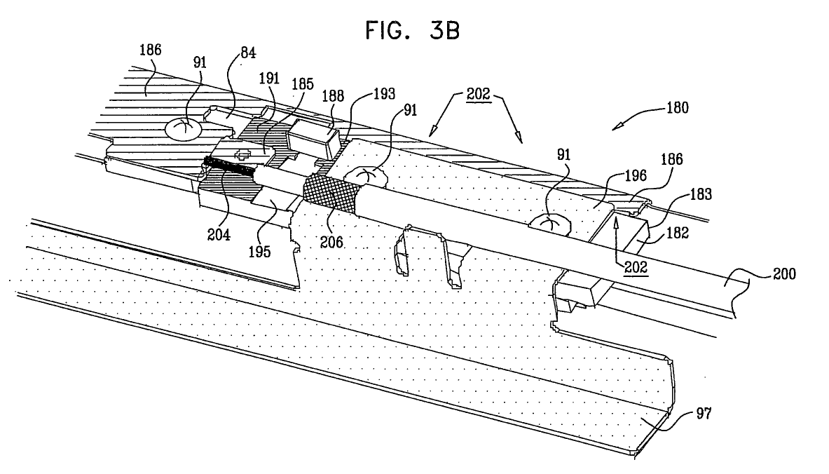

FIGS. 3A and 3B are schematic diagrams of a multiband antenna 180, according to a further alternative embodiment of the present invention. FIG. 3A is a perspective view of antenna 180, and FIG. 3B is a perspective view of a detail of the antenna. Apart from the differences described below, the operation of antenna 180 is generally similar to that of antenna 80 (FIGS. 2A and 2B), such that elements indicated by the same reference numerals in both antennas 80 and 180 are generally identical in construction and in operation.

Antenna 180 comprises an insulating substrate 182 of a PCB 183. Conductive strips 191 and 193 are formed on substrate 182, and the planes are separated by an insulating gap 195. A reactive matching circuit 188, comprising one or more reactive elements such as capacitors and/or inductors, is connected between conductive strips 191 and 193. A ground plate element 196, generally similar to element 96, is mounted on substrate 182 so as to galvanically connect to strip 193, and element 196 and substrate 192 are fixedly held in relation to carrier 82 by posts 91.

Antenna 180 comprises a section 186, which except as described below, is generally similar in structure and operation to section 86 of antenna 80. Rod 88 is galvanically connected to a portion of section 186. Section 186 does not comprise a section that is overlapped by element 196, but does include a feed post 185 that is galvanically connected to conducting strip 191.

Antenna 180 is fed by a coaxial cable 200 which has an outer conductor 206 of the cable galvanically connected to ground plate element 196. An inner conductor 204 of the cable is galvanically connected to feed post 185. Thus, section 186 is fed from inner conductor 204. Cable 200 couples antenna 180 with circuitry 210, typically mounted on PCB 99, which comprises a transmitter and/or a receiver.

Because of being mounted on substrate 182, ground plate element 196 is not coplanar with section 186, and there is an insulating gap 202 between section 186 and element 196. The gap provides capacitive coupling between the element and the section, substantially similar to the capacitive coupling provided by gap 102 of antenna 80. The capacitive coupling may be varied generally as described above for antennas 10 and 80.

The capacitive coupling, and the reactance of matching circuit 188, may be varied to match the impedance of antenna 180 in its radiating bands with the impedance of cable 200, as well as to vary the bandwidth of the radiating sections.

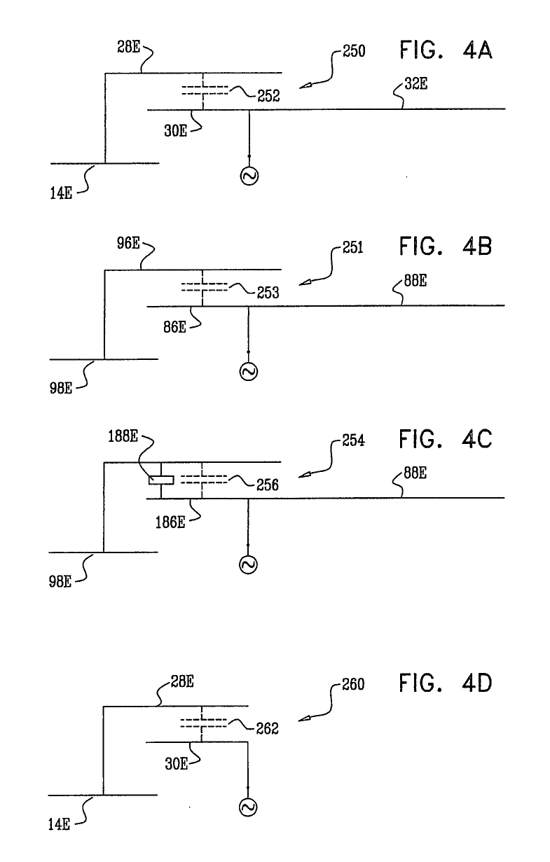

FIGS. 4A, 4B, 4C and 4D are schematic equivalent circuits of antennas, according to an embodiment of the present invention. In the equivalent circuits, sections of the circuits equivalent to a section of antennas 10, 80, and 180 are indicated by a suffix E. For example, in a diagram 250 (FIG. 4A), line 32E is equivalent to resonating section 32 (FIG. 1A). Diagram 250 is an equivalent circuit corresponding to inverted F antenna 10. The capacitive coupling between the ground element of the antenna and its radiating sections is schematically shown by a capacitor 252. A diagram 251 (FIG. 4B) is an equivalent circuit corresponding to inverted F antenna 10. The capacitive coupling between the ground element of the antenna and its radiating sections is schematically shown by a capacitor 253.

A diagram 254 (FIG. 4C) is an equivalent circuit corresponding to inverted F antenna 180. The capacitive coupling between the ground element of the antenna and its radiating sections are schematically shown by a capacitor 256.

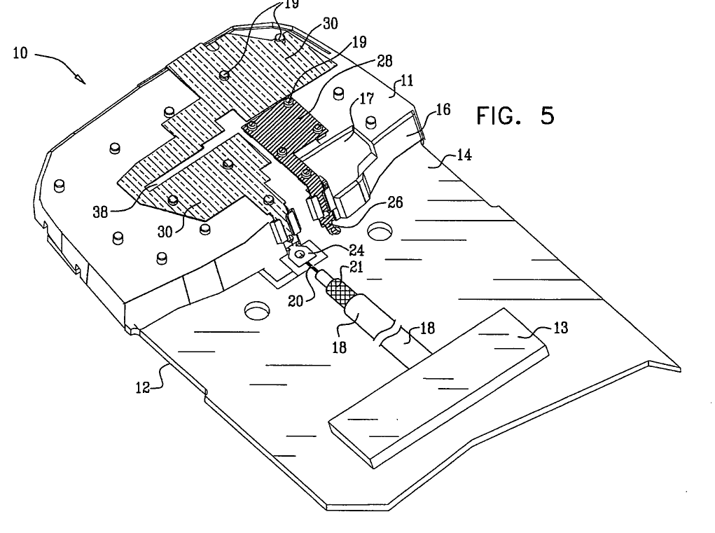

It will be understood that the principles of present invention are not limited to a particular type of antenna, such as the inverted F antennas exemplified above. A diagram 260 (FIG. 4D) is an equivalent circuit corresponding to a folded monopole having capacitive coupling to ground, indicated schematically by a capacitor 262. Such a folded monopole antenna could be produced, for example, by removing section 32 in antenna 10 (FIG. 1A), so that only section 30 is present to act as a radiator, as is illustrated in FIG. 5 below.

FIG. 5 is a schematic diagram of a folded monopole antenna 300, according to an embodiment of the present invention. Apart from the differences described below, the operation of antenna 300 is generally similar to that of antenna 10 (FIGS. 1A and 1B), such that elements indicated by the same reference numerals in both antennas 300 and 10 are generally identical in construction and in operation. Folded monopole antenna 300 does not comprise section 32. Apart from this, antenna 300 is generally similar to antenna 10, having a capacitive coupling to ground, and antenna 300 may be matched with circuitry 13, and tuned, in a similar way, by varying the capacitive coupling between section 30 and ground element 28.

Other types of antenna which may have a capacitive coupling to ground, such as a meander monopole and a multiband antenna having more than two resonating sections, will be apparent to those having ordinary skill in the art, and all such antennas are assumed to be comprised within the scope of the present invention.

It will be appreciated that embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. An antenna, comprising:
a ground plane;
a conductor having a feed post configured to galvanically connect to circuitry operative in a band of frequencies; and
a conductive plate galvanically connected to the ground plane and capacitively coupled to a region of the conductor so as to cause the conductor to resonate in the band of frequencies.

2. The antenna according to claim 1, wherein the conductor comprises a planar sheet.

3. The antenna according to claim 2, wherein the planar sheet and the conductive plate are in a common plane.

4. The antenna according to claim 3, wherein the conductive plate is capacitively coupled to the region of the conductor according to a capacitance, and wherein the conductive plate and the planar sheet are separated by one or more insulating spaces configured to form the capacitance.

5. The antenna according to claim 4, and comprising a dielectric which is inserted in the one or more insulating spaces to form the capacitance.

6. The antenna according to claim 2, wherein the planar sheet and the conductive plate are in different planes.

7. The antenna according to claim 6, wherein the conductive plate is capacitively coupled to the region of the conductor according to a capacitance, and wherein the conductive plate and the planar sheet are separated by one or more insulating spaces configured to form the capacitance.

8. The antenna according to claim 7, and comprising a dielectric which is inserted in the one or more insulating spaces to form the capacitance.

9. The antenna according to claim 6, wherein the conductive plate is capacitively coupled to the region of the conductor according to a capacitance, and wherein the conductive plate and the planar sheet overlap to form an insulating space therebetween so as to generate the capacitance.

10. The antenna according to claim 2, and comprising a conductive rod which is galvanically connected to a portion of the planar sheet.

11. The antenna according to claim 1, wherein the band of frequencies comprises two or more sub-bands of frequencies, and wherein the conductor comprises respective sections, each of the respective sections resonating in one of the two or more sub-bands of frequencies.

12. The antenna according to claim 1, wherein the ground plane comprises a dimension which is configured so as so as to cause the conductor and the ground plane to resonate in the band of frequencies.

13. The antenna according to claim 1, wherein the conductive plate is capacitively coupled to the region of the conductor according to a capacitance, and wherein the capacitance is arranged to match impedances of the circuitry and the conductor.

14. The antenna according to claim 1, wherein the region is selected according to a bandwidth of the band of frequencies.

15. The antenna according to claim 1, wherein the ground plane, the conductor, and the conductive plate are configured as an inverted F antenna.

16. The antenna according to claim 1, wherein the ground plane, the conductor, and the conductive plate are configured as a folded monopole antenna.

17. A method for forming an antenna, comprising:
providing a ground plane;
galvanically connecting a feed post of a conductor to circuitry operative in a band of frequencies;
galvanically connecting a conductive plate to the ground plane; and
capacitively coupling the conductive plate to a region of the conductor so as to cause the conductor to resonate in the band of frequencies.
